(19) United States
(12) Patent Application Publication
(10) Pub. No.: US 2021/0170657 A1
(43) Pub. Date: Jun. 10, 2021

(54) CONTROL DEVICE AND CONTROL METHOD FOR INJECTION MOLDING MACHINE

(71) Applicant: FANUC CORPORATION, Minamitsuru-gun (JP)

(72) Inventor: Atsushi HORIUCHI, Yamanashi-ken (JP)

(21) Appl. No.: 17/108,884

(22) Filed: Dec. 1, 2020

(30) Foreign Application Priority Data
Dec. 6, 2019 (JP) 2019-221328

(51) Int. Cl. B29C 45/77

(52) U.S. Cl. CPC B29C 45/77; B29C 2945/76006; B29C 2945/76187; B29C 2945/76943; B29C 2945/76498; B29C 2945/76665; B29C 2945/76846; B29C 2945/76367

(57) ABSTRACT

A control device for an injection molding machine including a cylinder into which a resin is supplied, a nozzle disposed at a distal end of the cylinder, and a screw that moves forward and rearward inside the cylinder, the injection molding machine performing metering of the resin while the resin is being melted inside the cylinder, by causing the screw to be moved rearward to a metering position, so as to keep the resin pressure at a metering pressure, includes a calculation unit configured to calculate a suck back distance or a suck back time period that achieves drawing in of a target volume of the resin inside the nozzle toward the cylinder, and a suck back control unit configured to cause the screw to be sucked back, based on the suck back distance or the suck back time period, after the screw has reached the metering position.

### CROSS-REFERENCE TO RELATED APPLICATION

This application is based upon and claims the benefit of priority from Japanese Patent Application No. 2019-221328 filed on Dec. 6, 2019, the contents of which are incorporated herein by reference.

### BACKGROUND OF THE INVENTION

### Field of the Invention

The present invention relates to a control device and a control method for an injection molding machine.

### Description of the Related Art

In the field of injection molding machines, a technique is known for preventing a molding failure in which a resin leaks from a cylinder, by reducing a resin pressure after the resin has been melted inside the cylinder. Such a technique is disclosed, for example, in Japanese Laid-Open Patent Publication No. 2008-230164. Such a molding failure in which the resin leaks from the cylinder is also referred to as drooling or leakage.

According to the disclosed technique, the injection molding machine performs sucking back in a sucking back step (pressure reducing step) following a metering step in which the resin is melted. Consequently, the resin pressure arrives at a set pressure (target pressure P0) which is capable of preventing drooling.

### SUMMARY OF THE INVENTION

Incidentally, when sucking back of the screw is performed, it is necessary for an operator to determine a suck back distance or a suck back time period in advance. However, in order to appropriately determine the suck back distance or the suck back time period, the operator is required to perform trial and error attempts while taking into consideration material properties of the resin and specifications of the injection molding machine. From the standpoint of the operator, performing such tasks has been a burden.

Thus, the present invention has the object of providing a control device and a control method for an injection molding machine, in which the suck back distance or the suck back time period can be appropriately and easily determined.

One aspect of the present invention is characterized by a control device for an injection molding machine, the injection molding machine including a cylinder into which a resin is supplied, a nozzle disposed at a distal end of the cylinder, and a screw configured to move forward and rearward and rotate inside the cylinder, the injection molding machine being configured to perform metering of the resin while the resin is being melted inside the cylinder, by causing the screw to be moved rearward to a predetermined metering position while being forwardly rotated, in a manner so as to keep a pressure of the resin at a predetermined metering pressure, the control device including a calculation unit configured to calculate, based on a target volume of the resin inside the nozzle that is drawn in from a side of the nozzle to a side of the cylinder, a suck back distance or a suck back time period that achieves drawing in of the target volume of the resin inside the nozzle to the side of the cylinder, and a suck back control unit configured to cause the screw to be sucked back on the basis of the suck back distance or the suck back time period, after the screw has reached the predetermined metering position.

Another aspect of the present invention is characterized by a control method for an injection molding machine, the injection molding machine including a cylinder into which a resin is supplied, a nozzle disposed at a distal end of the cylinder, and a screw configured to move forward and rearward and rotate inside the cylinder, the injection molding machine being configured to perform metering of the resin while the resin is being melted inside the cylinder, by causing the screw to be moved rearward to a predetermined metering position while being forwardly rotated, in a manner so as to keep a pressure of the resin at a predetermined metering pressure, the control method including a calculation step of calculating, based on a target volume of the resin inside the nozzle that is drawn in from a side of the nozzle to a side of the cylinder, a suck back distance or a suck back time period that achieves drawing in of the target volume of the resin inside the nozzle to the side of the cylinder, and a suck back control step of causing the screw to be sucked back on the basis of the suck back distance or the suck back time period, after the screw has reached the predetermined metering position.

According to the present invention, the control device and the control method for the injection molding machine are provided, in which the suck back distance or the suck back time period can be appropriately and easily determined.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a side view of an injection molding machine according to an embodiment of the present invention;

FIG. 2 is a schematic configuration diagram of an injection unit according to the embodiment;

FIG. 3 is a schematic configuration diagram of a control device according to the embodiment;

FIG. 4 is an example of a first table which is stored in a storage unit according to the present embodiment;

FIG. 5 is an example of a second table which is stored in the storage unit according to the present embodiment;

FIG. 6 is a flowchart showing an example of a control method for the injection molding machine according to the embodiment;

FIG. 7A is a schematic cross-sectional view showing an example of a state inside a cylinder at a point in time when a metering control step is completed;

FIG. 7B is a schematic cross-sectional view showing an example of a state inside the cylinder after sucking back has been executed;

FIG. 8 is a schematic configuration diagram of a control device according to a third modification; and

FIG. 9 is a schematic configuration diagram of a control device according to a fourth modification.

### DESCRIPTION OF THE PREFERRED EMBODIMENTS

Preferred embodiments of a control device and a control method for an injection molding machine according to the present invention will be presented and described in detail below with reference to the accompanying drawings. It should be noted that the directions discussed below conform respectively to the arrows shown in the drawings.

### EMBODIMENTS

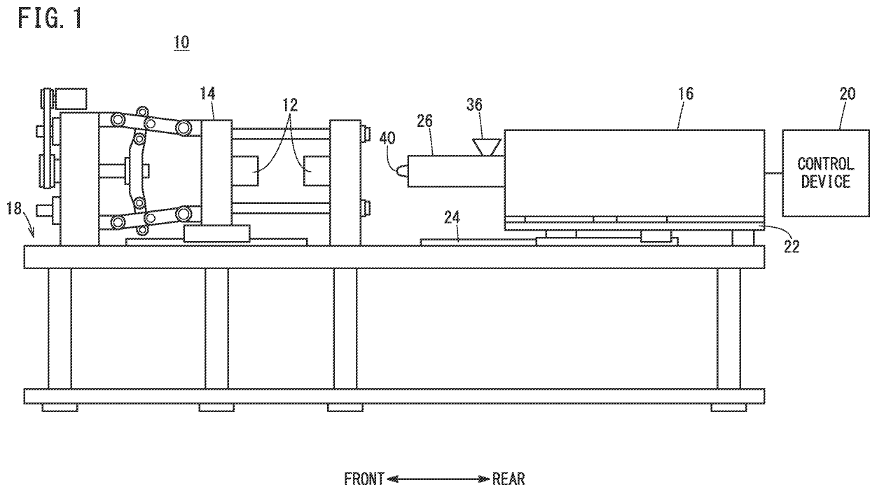

FIG. 1 is a side view of an injection molding machine 10 according to an embodiment of the present invention.

The injection molding machine 10 according to the present embodiment comprises a mold clamping unit 14 having a mold 12 that is capable of being opened and closed, an injection unit 16 that faces toward the mold clamping unit 14 in a front-rear direction, a machine base 18 on which such components are supported, and a control device 20 for the injection molding machine 10.

Among such components, the mold clamping unit 14 and the machine base 18 can be configured based on a known technique. Accordingly, in the following discussion, descriptions of the mold clamping unit 14 and the machine base 18 will be appropriately omitted.

Prior to describing the control device 20 of the present embodiment, at first, a description will be given concerning the injection unit 16, which is a control target of the control device 20.

The injection unit 16 is supported by a base 22. The base 22 is supported by a guide rail 24 installed on the machine base 18 so that the base 22 is capable of moving forward and rearward. Consequently, the injection unit 16 is capable of moving forward and rearward on the machine base 18. Further, the injection unit 16 can move closer to and away from the mold clamping unit 14.

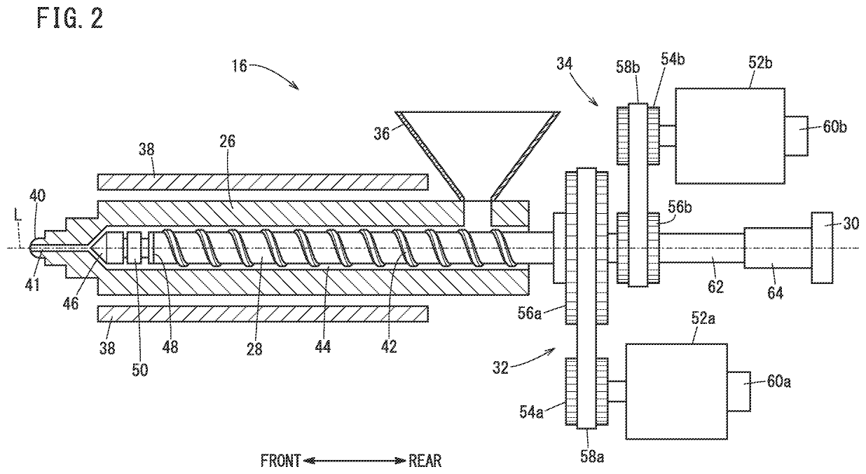

FIG. 2 is a schematic configuration diagram of the injection unit 16.

The injection unit 16 is equipped with a tubular shaped heating cylinder (cylinder) 26, a screw 28 provided inside the cylinder 26, a pressure sensor 30 provided on the screw 28, and a first drive device 32 and a second drive device 34 connected to the screw 28. According to the present embodiment, it is assumed that the cylinder 26 has a cylindrical shape.

The axial lines of the cylinder 26 and the screw 28 coincide with each other on an imaginary line L according to the present embodiment. Such a system may be referred to as an “in-line (in-line screw) system”. Further, the injection molding machine to which the in-line system is applied is also referred to as an “in-line type injection molding machine”.

Concerning advantages of an in-line type injection molding machine, several advantages are known. As examples thereof, there may be cited a point in which the structure of the injection unit 16 is simpler, and a point in which the maintainability thereof is excellent, as compared with other types of injection molding machines. In this instance, as another type of injection molding machine, for example, a preplasticating type injection molding machine is known.

As shown in FIG. 2, the cylinder 26 is equipped with a hopper 36 provided on a rearward side, a heater 38 for heating the cylinder 26, and a nozzle 40 provided on a frontward side thereof, i.e., at a distal end of the cylinder. Among such elements, the hopper 36 is provided with a supply port for supplying a molding material resin to the cylinder 26. Further, in the nozzle 40, there is formed a nozzle flow path 41 that communicates with the interior of the cylinder 26. An opening of the nozzle flow path 41 communicates with the interior and the exterior of the cylinder 26.

The shape of the nozzle flow path 41 is not particularly limited, however, according to the present embodiment, the shape thereof is cylindrical. Further, the shape of the opening of the nozzle flow path 41 is circular.

The screw 28 includes a spiral flight part 42 provided to span across the longitudinal (front-rear) direction thereof. The flight part 42, together with an inner wall of the cylinder 26, constitutes a spiral flow path 44. The spiral flow path 44 guides in a frontward direction the resin that is supplied from the hopper 36 into the cylinder 26.

The screw 28 includes a screw head 46 which is on a distal end on the frontward side, a check seat 48 that is disposed at a certain distance in a rearward direction from the screw head 46, and a check ring 50 (a ring for backflow-prevention) that is capable of moving between the screw head 46 and the check seat 48.

The check ring 50 moves in the frontward direction relatively with respect to the screw 28 when the check ring receives a forward pressure from the resin located on a rearward side of the check ring 50 itself. Relative movement of the check ring 50 in the frontward direction is performed, for example, at a later-described time of metering.

In this case, accompanying relative movement of the check ring 50, the flow path 44 is gradually opened. As a result, the resin can easily flow along the flow path 44 from the rearward side to the frontward side across the check seat 48.

Further, upon receiving a rearward pressure from the resin on the frontward side thereof, the check ring 50 moves in a rearward direction relatively with respect to the screw 28. Relative movement of the check ring 50 in the rearward direction is performed, for example, at a later-described time of injection.

In this case, the flow path 44 is gradually closed accompanying such relative movement of the check ring 50. As a result, the flow of the resin is suppressed along the flow path 44 from the frontward side toward the rearward side across the check seat 48. In particular, when the check ring 50 is retracted to the check seat 48, at least the resin on the frontward side of the check ring 50 is placed in a state in which the flow of the resin to the rearward direction across the check seat 48 is maximally suppressed.

The pressure sensor 30, such as a load cell or the like for sequentially detecting the pressure imposed on the resin inside the cylinder 26, is attached to the screw 28. Hereinafter, the phrase “the pressure applied to the resin inside the cylinder 26” may also be simply referred to as a “resin pressure (pressure of a resin)”.

The first drive device 32 serves to rotate the screw 28 inside the cylinder 26. The first drive device 32 comprises a servomotor 52a, a drive pulley 54a, a driven pulley 56a, and a belt member 58a. The drive pulley 54a rotates integrally with a rotary shaft of the servomotor 52a. The driven pulley 56a is disposed integrally on the screw 28. The belt member 58a transmits the rotational force of the servomotor 52a from the drive pulley 54a to the driven pulley 56a.

In accordance with the above-described first drive device 32, by the rotary shaft of the servomotor 52a being made to rotate, the rotational force thereof is transmitted to the screw 28 via the drive pulley 54a, the belt member 58a, and the driven pulley 56a. Consequently, the screw 28 can be rotated. Further, according to the above-described first drive device 32, by changing the direction in which the rotary shaft of the screw 28 of the servomotor 52a is rotated, in response to the changing, the direction of rotation of the screw can be switched between forward rotation and reverse rotation.

A position/speed sensor 60a is provided on the servomotor 52a. The position/speed sensor 60a detects the rotational position and the rotational speed of the rotary shaft of the servomotor 52a. The detection result therefrom is output to the control device 20. Consequently, the control device 20 is capable of calculating the amount of rotation (the rotation amount), the rotational acceleration, and the rotational speed of the screw 28, based on the rotational position and the rotational speed detected by the position/speed sensor 60a.

The second drive device 34 serves to move the screw 28 forward and rearward inside the cylinder 26. In the present embodiment, unless otherwise specified, the term “forward and rearward movement of the screw 28” implies forward and rearward movement of the screw 28 relative to the cylinder 26 inside which the screw 28 is provided.

The second drive device 34 comprises a servomotor 52b, a drive pulley 54b, a driven pulley 56b, a belt member 58b, a ball screw 62, and a nut 64. The drive pulley 54b rotates integrally with a rotary shaft of the servomotor 52b. The belt member 58b transmits the rotational force of the servomotor 52b from the drive pulley 54b to the driven pulley 56b. An axial line of the ball screw 62 and an axial line of the screw 28 coincide with each other on the imaginary line L. The nut 64 is screw-engaged with the ball screw 62.

In accordance with the above-described second drive device 34, by the rotary shaft of the servomotor 52b being made to rotate, the rotational force thereof is transmitted to the ball screw 62 via the drive pulley 54b, the belt member 58b, and the driven pulley 56b. The ball screw 62 converts the transmitted rotational force into linear motion and transmits the linear motion to the screw 28. Consequently, the screw 28 can be moved forward and rearward. Further, according to the above-described second drive device 34, by changing the direction in which the rotary shaft of the servomotor 52b is rotated, in response to the changing, the movement direction of the screw 28 can be switched between forward movement (advancing) and rearward movement (retracting).

A position/speed sensor 60b is provided on the servomotor 52b. The position/speed sensor 60b detects the rotational position and the rotational speed of the rotary shaft of the servomotor 52b, and is a similar sensor as the position/speed sensor 60a. The detection result therefrom is output to the control device 20. Consequently, the control device 20 is capable of calculating the forward position and the rearward position (rearward movement distance) of the screw 28 in the front-rear direction, as well as the rearward movement speed (forward and rearward movement speed) of the screw 28, based on the rotational position and the rotational speed detected by the position/speed sensor 60b.

Hereinafter, a description will be given of the plurality of steps performed in the injection molding machine 10 for obtaining a molded product. In particular, a description will be given focused on operations that can be performed by the injection unit 16.

The injection unit 16 melts (plasticizes) the resin supplied to the cylinder 26 due to being heated by the heater 38 and by the rotational force of the screw 28, while the resin is fed and compressed in the frontward direction along the flow path 44 due to forward rotation of the screw 28. Such forward rotation of the screw 28 is started in a state in which the screw 28 has been fully advanced inside the cylinder 26 (a state in which the volume of the metering region is at a minimum). Further, the screw 28 undergoes forward rotation at a predetermined rotational speed.

The screw 28 is gradually moved rearward relatively with respect to the cylinder 26, accompanying the resin being fed and compressed in the frontward direction. The rearward movement speed of the retracted screw 28 is controlled by the control device 20, in a manner so that the resin pressure is maintained in the vicinity of a predetermined value (metering pressure) P1. A description will be given later concerning the configuration of the control device 20.

The resin that is melted while being fed and compressed reaches a region (including the nozzle flow path 41) on the frontward side of the check seat 48 inside the cylinder 26, and is accumulated inside the region. Hereinafter, the region on the frontward side of the check seat 48 inside the cylinder 26 may also be referred to as a “metering region”.

The forward rotation and rearward movement of the screw 28 are performed until the screw 28 reaches a predetermined position (metering position) by way of such rearward movement. More specifically, until the screw 28 arrives at the metering position, the resin inside the cylinder 26 continues to be fed and compressed toward the metering region while being melted.

The step of carrying out forward rotation and rearward movement until the screw 28 arrives at the metering position to thereby accumulate the molten resin in the metering region may also be referred to as a “metering step” or simply “metering”. By performing such metering, a certain predetermined amount of the resin can be accumulated in the metering region.

Moreover, when metering is performed, it is necessary to specify in advance a metering pressure P1, and a predetermined rotational speed of the screw 28 that undergoes forward rotation. The metering pressure P1 and the predetermined rotational speed, which are specified in relation to metering, may also be referred to as “metering conditions”.

After the screw 28 has arrived at the metering position, a step of causing the resin pressure in the metering region to be reduced from the metering pressure P1 to the target pressure P0 is carried out by further causing the screw 28 to be retracted (moved rearward) from the metering position. Such a step may also be referred to as a “pressure reducing step” or simply a “reduction in pressure”.

Further, the operation of further moving rearward the screw 28 that has reached the metering position may also be referred to as “sucking back”. When sucking back is carried out, the volume of the metering region is enlarged corresponding to the distance over which the screw 28 is moved rearward. Consequently, an expansion in the volume of the resin in the metering region, and more specifically, a decrease in the density of the resin takes place, and as a result, the resin pressure in the metering region is reduced.

Sucking back is performed on the basis of a condition predetermined in relation to sucking back. Hereinafter, such a predetermined condition may also be referred to as a “suck back condition”. The suck back condition may include designation of a suck back distance L_{sb}, or designation of a suck back time period T_{sb}.

The suck back distance L_{sb} is a distance over which the screw 28 undergoes rearward movement relatively with respect to the cylinder 26 due to being sucked back. The suck back time period T_{sb} is a time period during which sucking back is continued.

As the target pressure P0, a pressure is specified which is smaller than the metering pressure P1 (P0<P1). Although the magnitude thereof is not particularly limited, for example, the value of atmospheric pressure (zero) can be specified.

The resin pressure in the metering region is in the vicinity of the metering pressure P1 immediately after the screw 28 has arrived at the metering position, i.e., immediately after metering has been carried out. By reducing the resin pressure from being in the vicinity of the metering pressure P1 to the target pressure P0, it is possible to weaken the forward momentum of the resin in the metering region, which has received the pressure directed toward the frontward direction in the metering step. Consequently, flowing of the resin in the metering region in the frontward direction is suppressed, and the occurrence of drooling is prevented.

In addition to being sucked back, causing the pressure of the resin in the metering region to be reduced can also be achieved by causing the screw 28 to be rotated (reversely rotated) in a direction opposite to that at the time of metering. However, in the present embodiment, a description concerning such a reduction in pressure due to reverse rotation is omitted.

After having carried out metering and a subsequent reduction in pressure, the resin accumulated in the metering region inside the cylinder 26 is filled into a cavity of the mold 12. Such a process is also referred to as an “injection step” or simply “injection”.

Injection is performed in a state in which the mold 12 of the mold clamping unit 14 and the nozzle 40 of the injection unit 16 are pressed against each other for contact with each other, so that the cavity of the mold 12 and the nozzle flow path 41 are placed in communication with each other. Pressing of the mold 12 and the nozzle 40 against each other may also be referred to as “nozzle touching”. When injection is carried out, the mold 12 is placed in a closed state, for example, by a well-known toggle mechanism provided in the mold clamping unit 14, and a mold clamping force is applied thereto. By advancement of the screw 28, the injection unit 16 pushes out the resin in the metering region, through the nozzle 40, into the cavity of the mold 12 to which the mold clamping force is applied. Consequently, the cavity is filled with the resin.

Immediately after injection, the screw 28 is in a state of being fully advanced inside the cylinder 26. Accordingly, after injection, the injection unit 16 can perform metering again. In this manner, the injection unit 16 is capable of efficiently and repeatedly carrying out metering, reduction in pressure, and injection in this order.

On the other hand, in the mold clamping unit 14, cooling and solidification of the resin that is filled in the mold 12 by executing injection, opening of the mold 12, and removal of the solidified resin (a molded product) are carried out. The step of cooling the resin that is filled in the mold 12 may also be referred to as a “cooling step” or simply “cooling”. Further, the step of opening the mold 12 may also be referred to as a “mold opening step” or simply “mold opening”. Further, the step of removing the molded product may also be referred to as a “removal step” or simply “removal”.

Between the steps of mold opening and removal, the molded product may be ejected from the mold 12 by a known ejector (ejecting pin) provided in the mold clamping unit 14. This step may also be referred to as an “ejecting step” or simply “ejection”. By ejection of the molded product, subsequent removal of the molded product can be easily accomplished.

Further, by closing the mold 12 after having removed the molded product, the mold 12 can be placed in a state in which the resin can be filled therein again. Further, the step of closing the mold 12 may also be referred to as a “mold closing step” or simply “mold closing”. In the foregoing manner, the mold clamping unit 14 can repeatedly perform cooling, mold opening, ejection, removal, and mold closing in this order.

The plurality of steps described above can be performed routinely as a “molding cycle”. By repeatedly executing the molding cycle, the injection molding machine 10 is capable of efficiently mass producing molded products.

Next, a description will be given concerning matters that can be considered in order to obtain high quality molded products. In order to obtain high quality molded products, it is desirable to reduce insofar as possible the occurrence of defects during execution of the molding cycle. Defects that occur during execution of the molding cycle may also be referred to as molding defects. The aforementioned drooling is a typical example of such a molding defect. Further, mixing of air (foreign material) into the metered resin may also be cited as an example of the molding defect.

In order to reduce any concern over drooling, it is necessary to appropriately perform sucking back in the pressure reducing step, by appropriately specifying the suck back distance L_{sb} or the suck back time period T_{sb}. For example, if the suck back distance L_{sb} or the suck back time period T_{sb} can be specified in a manner so that the resin filled inside the nozzle flow path 41 is drawn in from the nozzle 40 side to the cylinder 26 side at a certain volume amount or distance amount, any concern over drooling can be reduced.

However, the suck back distance L_{sb} or the suck back time period T_{sb}, by which the resin inside the nozzle flow path 41 is drawn in from the side of the nozzle 40 to the side of the cylinder 26 at a fixed distance amount or a fixed volume amount, is not obvious to the operator at first glance. In addition, if the specified suck back distance L_{sb} or the specified suck back time period T_{sb} is excessive, excessive drawing in of air from the distal end of the nozzle 40 into the nozzle flow path 41 occurs when sucking back is performed. In such a case, mixing of air (foreign material) into the resin disadvantageously takes place.

As can be appreciated from the above, in order for the operator to appropriately specify the suck back distance L_{sb} or the suck back time period T_{sb}, the operator is required to perform trial and error attempts while taking into consideration material properties of the resin and specifications of the injection molding machine 10. From the standpoint of the operator, performing such tasks is a burden.

Thus, according to the present embodiment, the injection molding machine 10 causes the control device 20 to calculate an appropriate suck back distance L_{sb} or an appropriate suck back time period T_{sb} in order to achieve drawing in of the resin inside the nozzle 40 to the cylinder 26 side at a target distance amount Lₜₐᵣ or a target volume amount Vₜₐᵣ. A description will be given in detail below concerning the control device 20 of the present embodiment.

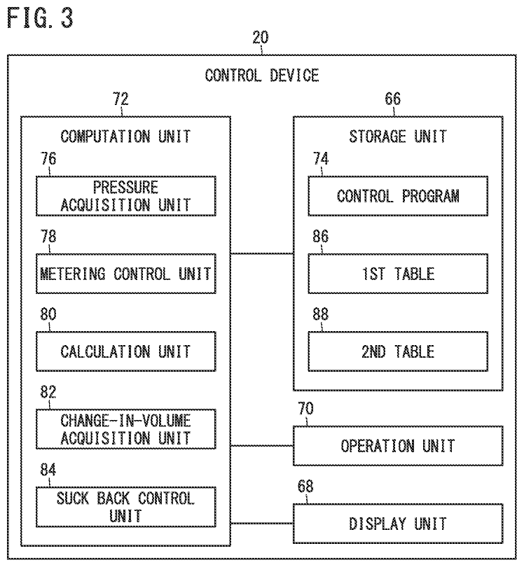

FIG. 3 is a schematic configuration diagram of the control device 20.

From among the mold clamping unit 14 and the injection unit 16 provided in the injection molding machine 10, the control device 20 according to the present embodiment controls at least the injection unit 16. The control device 20 is equipped with a storage unit 66, a display unit 68, an operation unit 70, and a computation unit 72.

Among these units, the storage unit 66 may include a volatile memory and a nonvolatile memory, neither of which are shown. The volatile memory can be configured by hardware such as a RAM (Random Access Memory) or the like. The nonvolatile memory can be configured by hardware such as a ROM (Read Only Memory), a flash memory, or the like.

A predetermined control program 74 for controlling the injection unit 16 is stored in advance in the storage unit 66. Further, the storage unit 66 appropriately stores information necessary for controlling the injection unit 16. Among such information, descriptions will be given below concerning information in the present embodiment which is deserving of particular explanation, as necessary.

Although not limited to this feature, the display unit 68, for example, is a display device equipped with a liquid crystal screen. The display unit 68 appropriately displays information concerning the controls performed by the control device 20.

Although not limited to this feature, the operation unit 70 comprises, for example, a keyboard, a mouse, or a touch panel that can be attached to the screen (liquid crystal screen) of the display unit 68. The operation unit 70 can be used by the operator in order to transmit commands to the control device 20.

The computation unit 72 may be configured by hardware such as, for example, a CPU (Central Processing Unit) or the like. The computation unit 72 includes a pressure acquisition unit 76, a metering control unit 78, a calculation unit 80, a change-in-volume acquisition unit 82, and a suck back control unit 84. These respective units can be realized by the computation unit 72 executing the control program 74 in cooperation with the storage unit 66. Hereinafter, descriptions will be given concerning each of such units.

The pressure acquisition unit 76 sequentially acquires the resin pressure detected by the pressure sensor 30. Although not limited to this feature, the acquired resin pressure is stored in the storage unit 66, for example, in the form of time series data. The data in relation to the stored resin pressure can be referred to by the metering control unit 78. Further, the operator may be made capable of monitoring such data by displaying the data on the display unit 68.

Among the controls of the injection unit 16, the metering control unit 78 carries out a control particularly in relation to metering. More specifically, initially, in the case that the metering conditions are stored in the storage unit 66, the metering control unit 78 acquires the metering pressure P1 and the predetermined rotational speed by referring to the storage unit 66. Moreover, the metering control unit 78 may acquire, as the metering pressure P1 or the predetermined rotational speed, values that are instructed by the operator via the operation unit 70.

When the metering control unit 78 acquires the metering conditions, the screw 28 is forwardly rotated at a predetermined rotational speed by supplying a drive current to the servomotor 52a of the first drive device 32. Further, while referring to the resin pressure acquired by the pressure acquisition unit 76, the metering control unit 78 adjusts the drive current supplied to the servomotor 52b of the second drive device 34, thereby causing the screw 28 to be moved rearward to the metering position while maintaining the resin pressure in the vicinity of the metering pressure P1.

The calculation unit 80 calculates the suck back distance L_{sb} or the suck back time period T_{sb} in order to achieve drawing in of the resin inside the nozzle flow path 41 to the cylinder 26 side at the target distance Lₜₐᵣ amount or the target volume Vₜₐᵣ amount. The operator may select which one of the suck back distance L_{sb} and the suck back time period T_{sb} is calculated. In the present embodiment, as an example, a description will be given in which the calculation unit 80 serves to calculate the suck back distance L_{sb}. A description will be given later in a modified example concerning a case in which the suck back time period T_{sb} is calculated.

In the calculation unit 80, calculation of the suck back distance L_{sb} is carried out on the basis of the target volume Vₜₐᵣ of the resin inside the nozzle 40 that is drawn in from the nozzle 40 side to the cylinder 26 side. More specifically, the calculation unit 80 according to the present embodiment calculates the suck back distance L_{sb} based on the following Equation (1). In Equation (1), the target volume Vₜₐᵣ is input thereto, and the suck back distance L_{sb} is output therefrom.

In the following equation, the term dV_{cyl} represents the amount of change (expansion) in the volume of the resin, in the case that the pressure of the resin (metered resin) in the metering region is reduced due to being sucked back from the metering pressure P1 to atmospheric pressure. The term D_{cyl} is a known numerical value, and represents the inner diameter of the cylinder 26. The character IC represents the circumferential ratio (pi).

$${L}_{sb} = \frac{{V}_{tar} + {dV}_{cyl}}{\frac{π}{4} \cdot {D}_{cyl}^{2}} \qquad ( 1 )$$

The target volume Vₜₐᵣ can also be indirectly obtained based on the shape of the nozzle 40, and more specifically, based on the shape of the nozzle flow path 41, and the target distance Lₜₐᵣ over which the resin inside the nozzle 40 is drawn in from the nozzle 40 side to the cylinder 26 side. For example, in the case of the present embodiment, the shape of the nozzle flow path 41 is cylindrical. In this case, the target volume Vₜₐᵣ, by which drawing in of the resin inside the nozzle 40 to the cylinder 26 side at the target distance Lₜₐᵣ amount is achieved, is obtained in accordance with the following Equation (2). In Equation (2), a function f(Lₜₐᵣ) is shown to which the target distance Lₜₐᵣ is input, and which outputs the target volume Vₜₐᵣ. In the following equation, D_{noz} is a known numerical value, and represents the inner diameter of the nozzle flow path 41.

$${V}_{tar} = f ( {L}_{tar} ) = \frac{π}{4} \cdot {D}_{noz}^{2} \cdot {L}_{tar} \qquad ( 2 )$$

As a shape of the nozzle flow path 41 other than a cylinder, for example, a tapered shape may be cited. Further, the nozzle 40, in which the shape of the opening of the nozzle flow path 41 is not circular but elliptical, may also be provided in the cylinder 26 of the injection molding machine 10. In the case that the present embodiment is applied to such a nozzle 40, the function f(Lₜₐᵣ) corresponding to such a shape of the target nozzle 40 may be obtained geometrically.

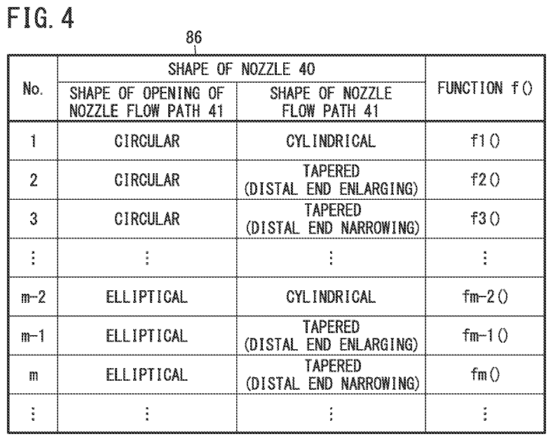

FIG. 4 is an example of a first table 86 which is stored in the storage unit 66 according to the present embodiment.

A corresponding relationship between the shape of the nozzle 40 and the function f(Lₜₐᵣ) specified in accordance with the shape of the nozzle 40 can be defined in the first table 86. The first table 86 can be stored in the storage unit 66. As shown in FIG. 4, in the case that the number of types of the shape of the nozzle 40 is greater than or equal to m, the number of types of the function f(Lₜₐᵣ) may be greater than or equal to m (m: a natural number of 1 or greater).

By referring to the first table 86 and based on the shape of the nozzle 40, the calculation unit 80 is capable of easily specifying the type of an appropriate function f(Lₜₐᵣ) in order to calculate the target volume Vₜₐᵣ from the target distance Lₜₐᵣ. Information regarding the shape of the nozzle 40, which serves as a key when the table is referred to, can be input by the operator, for example, via the operation unit 70.

The amount of change dV_{cyl} included in Equation (1) is acquired by the change-in-volume acquisition unit 82. The change-in-volume acquisition unit 82 acquires the amount of change dV_{cyl}, for example, by way of a calculation based on the following Equation (3). In the following equation, Lₘₑₜ represents the length of the distance by which the screw 28 is moved rearward in the metering step. The term ρ₀ is a known numerical value, and represents the density of the resin under the target pressure P0. The term ρ₁ represents the density of the resin under the metering pressure P1.

$${dV}_{cyl} = \frac{π}{4} \cdot {D}_{cyl}^{2} \cdot {L}_{met} \cdot ( \frac{{ρ}_{1}}{{ρ}_{0}} - 1 ) \qquad ( 3 )$$

The change-in-volume acquisition unit 82 applies to Equation (3) the density ρ₁, which is calculated based on the position of the screw 28, and the pressure of the resin when the screw 28 has reached the metering position. By calculating the density ρ₁ each time that metering is performed, the change-in-volume acquisition unit 82 is capable of acquiring the amount of change dV_{cyl} with higher accuracy. By the change-in-volume acquisition unit 82 acquiring the amount of change dV_{cyl} as accurately as possible, and by assigning the target volume Vₜₐᵣ acquired from Equation (2) and the amount of change dV_{cyl} acquired from Equation (3) to Equation (1), the calculation unit 80 can calculate the suck back distance L_{sb} with high accuracy.

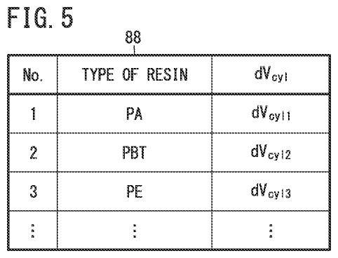

It should be noted that, according to the present embodiment, it is not essential that the density ρ₁ be calculated each time that metering is performed. More specifically, a value of the density ρ₁ which is obtained experimentally in advance may be applied to Equation (3). FIG. 5 is an example of a second table 88 which is stored in the storage unit 66 according to the present embodiment.

In the case that the density ρ₀ and the density ρ₁ are experimentally determined in advance for each type of resin, the amount of change dV_{cyl} for each type of resin can be prepared in advance. In this case, as shown in FIG. 5, a second table 88, in which the type of resin, and the amount of change dV_{cyl} corresponding to the type of resin are associated with each other, can be prepared and stored in the storage unit 66. Consequently, by referring to the second table 88 and based on the type of resin, the change-in-volume acquisition unit 82 is capable of easily acquiring the amount of change dV_{cyl}. For example, in the case that the type of resin is “PA (polyamide)”, the change-in-volume acquisition unit 82 can easily acquire the value of the amount of change dV_{cyl} (dV_{cyl1}) corresponding to PA by referring to the second table 88. Information regarding the type of resin, which serves as a key when the table is referred to, can be input by the operator, for example, via the operation unit 70.

Moreover, the second table 88 may be merged with the above-described first table 86. More specifically, in the present embodiment, a table may be created in which the shape of the nozzle 40, the function f(Lₜₐᵣ) corresponding to the shape of the nozzle 40, the type of resin, and the amount of change dV_{cyl} corresponding to the type of resin are associated with each other.

From among the controls for the injection unit 16, in particular, the suck back control unit 84 performs a control in relation to reducing pressure due to sucking back. After the screw 28 has reached the predetermined metering position, by supplying a drive current to the servomotor 52b, the suck back control unit 84 causes the screw 28 to be sucked back based on the suck back distance L_{sb} or the suck back time period T_{sb} calculated by the calculation unit 80.

Moreover, according to the present embodiment, it is assumed that a rearward movement speed (suck back speed) U_{sb} of the screw 28 during sucking back is determined in advance.

An exemplary configuration of the control device 20 has been described above. It should be noted that the configuration of the control device 20 is not limited to the above description. For example, the control device 20 may further comprise a configuration for controlling the mold clamping unit 14. Further, the injection molding machine 10 which is capable of being controlled by the control device 20 is not limited to being an in-line type injection molding machine.

Next, a description will be given below concerning a control method for the injection molding machine 10 according to the present embodiment.

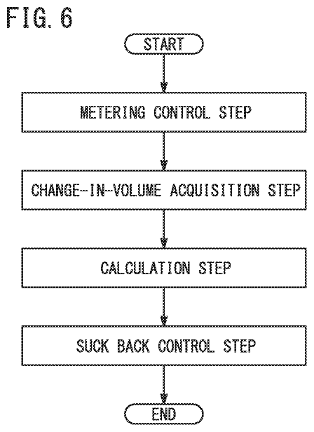

FIG. 6 is a flowchart showing an example of the control method for the injection molding machine 10 according to the present embodiment.

The control method for the injection molding machine 10 according to the present embodiment (hereinafter, simply referred to as a “control method”) is executed by the above-described control device 20. As shown in FIG. 6, such a control method includes at least a calculation step and a suck back control step. Hereinafter, a description will be given concerning such a control method.

As a premise, hereinafter, a description will be given concerning a case in which the suck back distance L_{sb} is calculated from among the suck back distance L_{sb} and the suck back time period T_{sb}.

It is assumed that the control method according to the present embodiment is initiated from a metering control step (metering step). The present step is executed by the metering control unit 78 in the present embodiment.

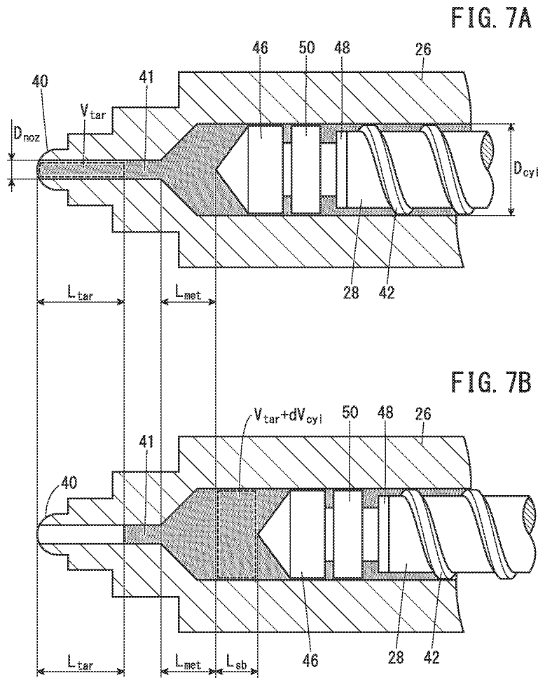

FIG. 7A is a schematic cross-sectional view showing an example of a state inside the cylinder 26 at a point in time when the metering control step is completed.

The metering control step is continued until the screw 28 arrives at the metering position, and more specifically, until the rearward movement distance of the screw 28 reaches the predetermined distance Lₘₑₜ. By performing the metering control step, as shown in FIG. 7A, the molten resin is filled in the metering region on the frontward side of the check ring 50 including the nozzle flow path 41.

When the screw 28 arrives at the metering position, the change-in-volume acquisition step is initiated. The present step is executed by the change-in-volume acquisition unit 82 in the present embodiment. In the present step, initially, the density ρ₁ of the resin in the metering region under the predetermined metering pressure P1 is calculated, based on the position (rearward movement distance) of the screw 28 and the pressure of the resin at the time of having reached the metering position. In addition, the amount of change dV_{cyl} is acquired based on Equation (3) which has already been described. Moreover, in the case that the second table 88 is stored in the storage unit 66 in advance, the amount of change dV_{cyl} may be acquired by referring to the second table 88.

Subsequently, the calculation step is executed. In the present step, the suck back distance L_{sb} is calculated based on the target volume Vₜₐᵣ. Such a calculation is performed based on Equation (1) which has already been described.

Specification of the target volume Vₜₐᵣ required for calculating the suck back distance L_{sb} is carried out by the operator via the operation unit 70. In the following example, it is assumed that the target volume Vₜₐᵣ has been calculated by inputting into Equation (2) the target distance Lₜₐᵣ instructed by the operator. However, the present embodiment is not limited to the description given above. For example, as the target volume Vₜₐᵣ, a default value specified by the manufacturer of the injection molding machine 10 may be automatically specified.

FIG. 7B is a schematic cross-sectional view showing an example of a state inside the cylinder 26 after sucking back has been executed.

After the calculation step, the suck back control step is executed in which the screw 28 is sucked back based on the calculated suck back distance L_{sb}. The present step is executed by the suck back control unit 84 in the present embodiment. The suck back control unit 84 continues sucking back the screw 28 at the predetermined suck back speed U_{sb} until the screw 28 is moved rearward by the suck back distance L_{sb}.

According to the above-described control method, it is possible to easily calculate the appropriate suck back distance L_{sb}, which achieves drawing in of the resin inside the nozzle 40 to the side of the cylinder 26 at the target volume Vₜₐᵣ (over the target distance Lₜₐᵣ) amount.

More specifically, according to the present embodiment, the control device 20 and the control method for the injection molding machine 10 are provided, in which the suck back distance L_{sb} can be appropriately and easily determined. The operator can easily produce high quality molded products by using the injection molding machine 10 which is equipped with the control device 20 of the present embodiment.

### [Modifications]

Although an embodiment has been described above as one example of the present invention, it goes without saying that various modifications or improvements are capable of being added to the above-described embodiment. It is clear from the scope of the claims that other modes to which such modifications or improvements have been added can be included within the technical scope of the present invention.

### (Modification 1)

In the present modification, as a supplement to the embodiment, an example of a case in which the suck back time period T_{sb} is obtained will be disclosed.

The suck back time period T_{sb} corresponding to the target distance Lₜₐᵣ can be obtained by the following Equation (4). In the following equation, the term U_{sb} is the suck back speed. Moreover, even in this case, the target volume Vₜₐᵣ can be indirectly calculated from the target distance Lₜₐᵣ based on Equation (2).

$${T}_{sb} = \frac{{L}_{sb}}{{U}_{sb}} = \frac{{V}_{tar} + {dV}_{cyl}}{\frac{π}{4} \cdot {D}_{cyl}^{2} \cdot {U}_{sb}} \qquad ( 4 )$$

By using the above Equation (4), the calculation unit 80 is capable of easily and appropriately calculating the suck back time period T_{sb} which achieves drawing in of the resin inside the nozzle 40 at the target volume Vₜₐᵣ (over the target distance Lₜₐᵣ) toward the cylinder 26.

In the foregoing manner, according to the present modification, the control device 20 and the control method for the injection molding machine 10 are provided, in which the suck back time period T_{sb} can be appropriately and easily determined.

### (Modification 2)

In the case that the target volume Vₜₐᵣ is in excess of a predetermined limit value Vₘₐₓ, the calculation unit 80 may calculate the suck back distance L_{sb} or the suck back time period T_{sb} after having limited the target volume Vₜₐᵣ to a value less than or equal to the limit value Vₘₐₓ. Such a limitation can be applied not only to the target volume Vₜₐᵣ instructed by the operator, but also to the target volume Vₜₐᵣ that is specified from the target distance Lₜₐᵣ.

The limit value Vₘₐₓ, for example, is a value specified by the manufacturer of the injection molding machine 10. The limit value Vₘₐₓ may also be instructed by the operator via the operation unit 70.

Consequently, in the case that the target volume Vₜₐᵣ is in excess of the limit value Vₘₐₓ, any concern over an excessive suck back distance L_{sb} being calculated on the basis of such an excessive target volume Vₜₐᵣ can be reduced. Similarly, any concern over an excessive suck back time period T_{sb} being calculated on the basis of such an excessive target volume Vₜₐᵣ can be reduced.

### (Modification 3)

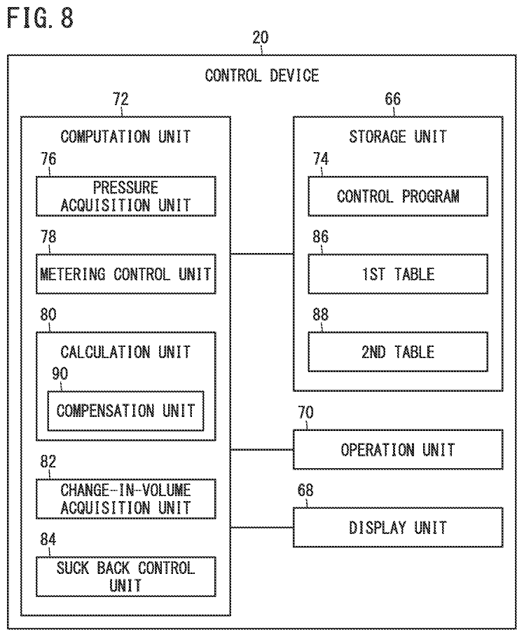

FIG. 8 is a schematic configuration diagram of the control device 20 according to a third modification.

The calculation unit 80 may include a compensation unit 90 which, in the case that the calculated suck back distance L_{sb} is in excess of an upper limit value L. of the predetermined distance, compensates (modifies) the suck back distance L_{sb} to the upper limit value Lₘₐₓ. The upper limit value Lₘₐₓ, for example, is a value specified by the manufacturer of the injection molding machine 10. The upper limit value Lₘₐₓ may also be instructed by the operator via the operation unit 70.

In accordance with this feature, any concern over sucking back being performed on the basis of such an excessive suck back distance L_{sb} can be reduced.

Further, the present modification can also be applied in the case that the calculation unit 80 calculates the suck back time period T_{sb}. More specifically, the calculation unit 80 may include the compensation unit 90 which, in the case that the calculated suck back time period T_{sb} is in excess of an upper limit value Tₘₐₓ of the predetermined time period, compensates (modifies) the suck back time period T_{sb} to the upper limit value Tₘₐₓ. The upper limit value Tₘₐₓ, for example, is a value specified by the manufacturer of the injection molding machine 10, similarly to the case of the upper limit value Lₘₐₓ. The upper limit value Tₘₐₓ may also be instructed by the operator via the operation unit 70.

In accordance with this feature, any concern over sucking back being performed on the basis of such an excessive suck back time period T_{sb} can be reduced.

### (Modification 4)

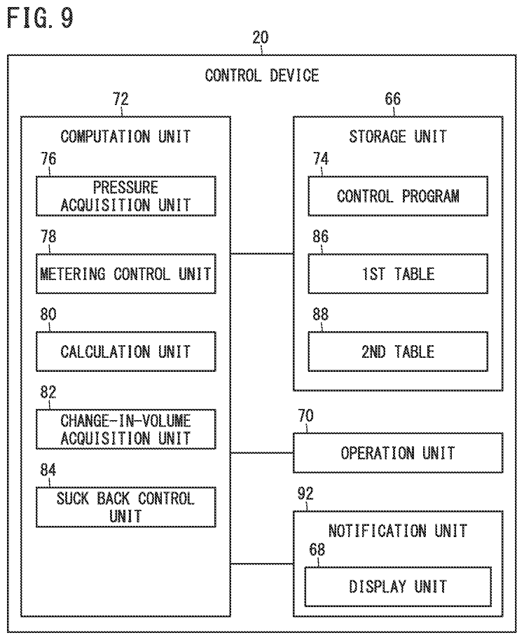

FIG. 9 is a schematic configuration diagram of the control device 20 according to a fourth modification.

The control device 20 may further be equipped with a notification unit 92 that issues a notification of the calculated suck back distance L_{sb} or the calculated suck back time period T_{sb}. Such a notification can be performed, for example, by causing the suck back distance L_{sb} or the suck back time period T_{sb} to be displayed on the display unit 68.

In accordance with this feature, the operator is capable of easily grasping the suck back distance L_{sb} or the suck back time period T_{sb} calculated by the control device 20.

### (Modification 5)

The amount of change dV_{cyl} need not necessarily be acquired. More specifically, in the calculation in which Equation (1) is used, the amount of change dV_{cyl} may always be treated as zero. Even in this case, the control device 20 can calculate a minimum required suck back distance L_{sb} or a minimum required suck back time period T_{sb} for achieving drawing in of the target volume Vₜₐᵣ amount (or the target distance Lₜₐᵣ amount) of the resin inside the nozzle 40.

The present modification enables the operator to know the minimum value of the suck back distance L_{sb} or the suck back time period T_{sb} to be specified as the suck back condition. By referring to the suck back distance L_{sb} or the suck back time period T_{sb} calculated according to the present modification, the operator may newly specify the suck back distance L_{sb} or the suck back time period T_{sb}.

According to the present modification, the burden on the operator can be significantly reduced, in that it is possible to easily grasp the minimum value of the suck back distance L_{sb} or the suck back time period T_{sb} that should be specified. Further, according to the present modification, the change-in-volume acquisition unit 82 can be omitted from the configuration of the control device 20. Therefore, the configuration of the control device 20 can be made simpler than in the case of the embodiment.

### (Modification 6)

The above-described embodiment and the modifications thereof may be appropriately combined within a range in which no technical inconsistencies occur.

[Inventions that can be Obtained from the Embodiment]

The inventions that can be grasped from the above-described embodiment and the modifications thereof will be described below.

### <First Invention>

The control device (20) for the injection molding machine (10) is provided. The injection molding machine includes the cylinder (26) into which the resin is supplied, the nozzle (40) disposed at the distal end of the cylinder (26), and the screw (28) that moves forward and rearward and rotates inside the cylinder (26). The injection molding machine performs metering of the resin while the resin is being melted inside the cylinder (26), by causing the screw (28) to be moved rearward to the predetermined metering position while being rotated, in a manner so as to keep the resin pressure at the predetermined metering pressure (P1). The control device includes the calculation unit (80) that calculates, based on the target volume (Vₜₐᵣ) of the resin inside the nozzle (40) that is drawn in from the side of the nozzle (40) to the side of the cylinder (26), the suck back distance (L_{sb}) or the suck back time period (T_{sb}) in order to achieve drawing in of the target volume (Vₜₐᵣ) of the resin inside the nozzle (40) to the side of the cylinder (26), and the suck back control unit (84) which causes the screw (28) to be sucked back on the basis of the suck back distance (L_{sb}) or the suck back time period (T_{sb}), after the screw (28) has reached the predetermined metering position.

In accordance with such features, the control device (20) for the injection molding machine (10) is provided, in which the suck back distance (L_{sb}) or the suck back time period (T_{sb}) can be appropriately and easily determined.

There may further be provided the change-in-volume acquisition unit (82) which acquires, after the screw (28) has reached the predetermined metering position, the amount of change (dV_{cyl}) in the volume of the resin metered inside the cylinder (26) while the pressure of the resin is reduced from the predetermined metering pressure (P1) to atmospheric pressure (P0), wherein the calculation unit (80) calculates the suck back distance (L_{sb}) or the suck back time period (T_{sb}) based on the amount of change (dV_{cyl}) and the target volume (Vₜₐᵣ). In accordance with such features, the calculation unit (80) can accurately calculate the suck back distance (L_{sb}) or the suck back time period (T_{sb}).

There may further be provided the pressure acquisition unit (76) that acquires the resin pressure, wherein the change-in-volume acquisition unit (82) acquires the amount of change (dV_{cyl}) based on the distance (Lₘₑₜ) over which the screw (28) is moved rearward during metering, and the pressure (P1) of the resin when the screw (28) has reached the predetermined metering position. In accordance with such features, the change-in-volume acquisition unit (82) can acquire the amount of change (dV_{cyl}) with higher accuracy.

There may further be provided the operation unit (70) through which the operator instructs the target volume (Vₜₐᵣ). In accordance with this feature, the suck back distance (L_{sb}) or the suck back time period (T_{sb}), which achieves drawing in of the resin inside the nozzle (40) to the side of the cylinder (26) at the target volume (Vₜₐᵣ) amount instructed by the operator, can be calculated.

There may further be provided the storage unit (66) in which there is stored the first table (86) in which the plurality of functions are defined in association with the shape of the nozzle (40), the functions being configured to calculate the target volume (Vₜₐᵣ) based on the shape of the nozzle (40) and the target distance (Lₜₐᵣ) over which the resin inside the nozzle (40) is drawn in from the side of the nozzle (40) to the side of the cylinder (26), wherein the calculation unit (80) selects from within the first table (86) the function corresponding to the shape of the nozzle (40) provided on the cylinder (26), and calculates the suck back distance (L_{sb}) or the suck back time period (T_{sb}) based on the selected function and the target distance (Lₜₐᵣ). In accordance with such features, the calculation unit (80) can easily specify the appropriate function for calculating the target volume (Vₜₐᵣ) from the target distance (Lₜₐᵣ).

The storage unit (66) may further store therein the second table (88) in which the amount of change (dV_{cyl}) and the type of resin are associated with each other, wherein the change-in-volume acquisition unit (82) acquires the amount of change (dV_{cyl}) by referring to the second table (88), and based on the type of resin. In accordance with such features, the change-in-volume acquisition unit (82) is capable of easily acquiring the amount of change (dV_{cyl}).

In the first invention, when the change-in-volume acquisition unit (82) is provided, and in the case that the target volume (Vₜₐᵣ) is not calculated from the target distance (Lₜₐᵣ), there may further be provided the storage unit (66) in which there is stored the table (88) in which the amount of change (dV_{cyl}) and the type of resin are associated with each other. In accordance with such features, the change-in-volume acquisition unit (82) is capable of easily acquiring the amount of change (dV_{cyl}), even in the case that the target volume (Vₜₐᵣ) is not calculated from the target distance (Lₜₐᵣ).

There may further be provided the operation unit (70) through which the operator instructs the target distance (Lₜₐᵣ). In accordance with this feature, the suck back distance (L_{sb}) or the suck back time period (T_{sb}), which achieves drawing in of the resin inside the nozzle (40) to the side of the cylinder (26) over the target distance (Lₜₐᵣ) amount instructed by the operator, can be calculated.

In the case that the target volume (Vₜₐᵣ) is in excess of the predetermined limit value (Vₘₐₓ), the calculation unit (80) may calculate the suck back distance (L_{sb}) or the suck back time period (T_{sb}) after having limited the target volume (Vₜₐᵣ) to a value less than or equal to the limit value (Vₘₐₓ). In accordance with this feature, any concern over an excessive suck back distance (L_{sb}) being calculated on the basis of an excessive target volume (Vₜₐᵣ) can be reduced.

The calculation unit (80) may further include the compensation unit (90) configured to, in the case that the calculated suck back distance (L_{sb}) or the calculated suck back time period (T_{sb}) is in excess of the predetermined upper limit value (Lₘₐₓ, Tₘₐₓ), compensate the suck back distance (L_{sb}) or the suck back time period (T_{sb}) to the upper limit value (Lₘₐₓ, Tₘₐₓ). In accordance with this feature, any concern over sucking back being performed on the basis of such an excessive suck back distance (L_{sb}) or an excessive suck back time period (T_{sb}) can be reduced.

There may further be provided the notification unit (92) that issues a notification of the calculated suck back distance (L_{sb}) or the calculated suck back time period (T_{sb}). In accordance with this feature, the operator is capable of easily grasping the suck back distance (L_{sb}) or the suck back time period (T_{sb}) calculated by the control device (20).

### <Second Invention>

The control method for the injection molding machine (10) is provided. The injection molding machine includes the cylinder (26) into which the resin is supplied, the nozzle (40) disposed at the distal end of the cylinder (26), and the screw (28) that moves forward and rearward and rotates inside the cylinder (26). The injection molding machine performs metering of the resin while the resin is being melted inside the cylinder (26), by causing the screw (28) to be moved rearward to the predetermined metering position while being forwardly rotated, in a manner so as to keep the resin pressure at the predetermined metering pressure (P1). The control method includes the calculation step of calculating, based on the target volume (Vₜₐᵣ) of the resin inside the nozzle (40) that is drawn in from the side of the nozzle (40) toward the side of the cylinder (26), the suck back distance (L_{sb}) or the suck back time period (T_{sb}) that achieves drawing in of the target volume (Vₜₐᵣ) of the resin inside the nozzle (40) to the side of the cylinder (26), and the suck back control step of causing the screw (28) to be sucked back on the basis of the suck back distance (L_{sb}) or the suck back time period (T_{sb}), after the screw (28) has reached the predetermined metering position.

In accordance with such features, the control method for the injection molding machine (10) is provided, in which the suck back distance (L_{sb}) or the suck back time period (T_{sb}) can be appropriately and easily determined.

What is claimed is:

1. A control device for an injection molding machine, the injection molding machine including a cylinder into which a resin is supplied, a nozzle disposed at a distal end of the cylinder, and a screw configured to move forward and rearward and rotate inside the cylinder, the injection molding machine being configured to perform metering of the resin while the resin is being melted inside the cylinder, by causing the screw to be moved rearward to a predetermined metering position while being forwardly rotated, in a manner so as to keep a pressure of the resin at a predetermined metering pressure, the control device comprising:
a calculation unit configured to calculate, based on a target volume of the resin inside the nozzle that is drawn in from a side of the nozzle to a side of the cylinder, a suck back distance or a suck back time period that achieves drawing in of the target volume of the resin inside the nozzle to the side of the cylinder; and
a suck back control unit configured to cause the screw to be sucked back, based on the suck back distance or the suck back time period, after the screw has reached the predetermined metering position.

2. The control device for the injection molding machine according to claim 1, further comprising:
a change-in-volume acquisition unit configured to acquire, after the screw has reached the predetermined metering position, an amount of change in a volume of the resin metered inside the cylinder while the pressure of the resin is reduced from the predetermined metering pressure to atmospheric pressure;
wherein the calculation unit calculates the suck back distance or the suck back time period based on the amount of change and the target volume.

3. The control device for the injection molding machine according to claim 2, further comprising:
a pressure acquisition unit configured to acquire the pressure of the resin;
wherein the change-in-volume acquisition unit acquires the amount of change based on a distance over which the screw is moved rearward during metering, and the pressure of the resin when the screw has reached the predetermined metering position.

4. The control device for the injection molding machine according to claim 2, further comprising:
a storage unit configured to store a table in which the amount of change and a type of the resin are associated with each other;
wherein the change-in-volume acquisition unit acquires the amount of change by referring to the table, and based on the type of the resin.

5. The control device for the injection molding machine according to claim 1, further comprising an operation unit through which an operator instructs the target volume.

6. The control device for the injection molding machine according to claim 1, further comprising:
a storage unit configured to store a first table in which a plurality of functions are defined in association with a shape of the nozzle, the functions being configured to calculate the target volume based on the shape of the nozzle and a target distance over which the resin inside the nozzle is drawn in from the side of the nozzle to the side of the cylinder;
wherein the calculation unit selects from within the first table the function corresponding to the shape of the nozzle provided on the cylinder, and calculates the suck back distance or the suck back time period based on the selected function and the target distance.

7. The control device for the injection molding machine according to claim 6, further comprising:
a change-in-volume acquisition unit configured to acquire, after the screw has reached the predetermined metering position, an amount of change in a volume of the resin metered inside the cylinder while the pressure of the resin is reduced from the predetermined metering pressure to atmospheric pressure;
wherein the calculation unit calculates the suck back distance or the suck back time period based on the amount of change and the target volume.

8. The control device for the injection molding machine according to claim 7, further comprising:
a pressure acquisition unit configured to acquire the pressure of the resin;
wherein the change-in-volume acquisition unit acquires the amount of change based on a distance over which the screw is moved rearward during metering, and the pressure of the resin when the screw has reached the predetermined metering position.

9. The control device for the injection molding machine according to claim 7, wherein:
the storage unit further stores therein a second table in which the amount of change and a type of the resin are associated with each other; and
the change-in-volume acquisition unit acquires the amount of change by referring to the second table, and based on the type of the resin.

10. The control device for the injection molding machine according to claim 6, further comprising an operation unit through which an operator instructs the target distance.

11. The control device for the injection molding machine according to claim 1, wherein in a case that the target volume is in excess of a predetermined limit value, the calculation unit calculates the suck back distance or the suck back time period after having limited the target volume to a value less than or equal to the limit value.

12. The control device for the injection molding machine according to claim 1, wherein the calculation unit further comprises a compensation unit configured to, in a case that the calculated suck back distance or the calculated suck back time period is in excess of a predetermined upper limit value, compensate the suck back distance or the suck back time period to the upper limit value.

13. The control device for the injection molding machine according to claim 1, further comprising a notification unit configured to issue a notification of the calculated suck back distance or the calculated suck back time period.

14. A control method for an injection molding machine, the injection molding machine including a cylinder into which a resin is supplied, a nozzle disposed at a distal end of the cylinder, and a screw configured to move forward and rearward and rotate inside the cylinder, the injection molding machine being configured to perform metering of the resin while the resin is being melted inside the cylinder, by causing the screw to be moved rearward to a predetermined metering position while being forwardly rotated, in a manner so as to keep a pressure of the resin at a predetermined metering pressure, the control method comprising:
a calculation step of calculating, based on a target volume of the resin inside the nozzle that is drawn in from a side of the nozzle to a side of the cylinder, a suck back distance or a suck back time period that achieves drawing in of the target volume of the resin inside the nozzle to the side of the cylinder; and
a suck back control step of causing the screw to be sucked back, based on the suck back distance or the suck back time period, after the screw has reached the predetermined metering position.
